(19) United States
(12) Patent Application Publication
(10) Pub. No.: US 2026/0153674 A1
(43) Pub. Date: Jun. 4, 2026

(54) OPTICAL COUPLING STRUCTURE

(71) Applicants: COMMISSARIAT A L'ENERGIE ATOMIQUE ET AUX ENERGIES ALTERNATIVES, Paris (FR); THALES, Meudon (FR)

(72) Inventors: Yohan DESIERES, Grenoble cedex 09 (FR); Clément BEN BRAHAM, Grenoble cedex 09 (FR)

(73) Assignees: COMMISSARIAT A L'ENERGIE ATOMIQUE ET AUX ENERGIES ALTERNATIVES, Paris (FR); THALES, Meudon (FR)

(21) Appl. No.: 19/400,306

(22) Filed: Nov. 25, 2025

(30) Foreign Application Priority Data
Nov. 29, 2024 (FR) FR2413235

(51) Int. Cl. G02B 6/122; G02B 6/12; G02B 6/136

(52) U.S. Cl. CPC G02B 6/1228; G02B 6/1223; G02B 6/136; G02B 2006/1204; G02B 2006/12061; G02B 2006/12097; G02B 2006/12142; G02B 2006/12147

(57) ABSTRACT

The invention relates to a coupling structure coupling a first optical mode to a second, the effective index of the second being strictly greater than that of the first. It comprises a first and a second waveguide configured to guide respectively the first and second optical modes. The core of the first waveguide extends into a proximal section and a distal section. The second waveguide includes a base and a ridge. A hybrid waveguide, interposed between the first and second waveguides, includes the proximal section and an extension of the base, arranged to cooperate to guide an intermediate optical mode. The effective index of the intermediate optical mode is strictly greater than the effective index of the second optical mode. A modal transition section including the distal section, extends from the hybrid waveguide to the second waveguide to couple the intermediate optical mode to the second optical mode.

### TECHNICAL FIELD

The field of the invention is that of integrated photonic optical coupling structures, such as, for example, an optical coupling structure between a first waveguide, and a second waveguide, the second waveguide being able to be optically coupled to one or more active photonic components.

### PRIOR ART

In the field of integrated photonics, it is often necessary to couple waveguides made of different materials, in particular to design devices implementing active photonic components. These devices are now widely used in the field of telecommunications, data exchange between chips, digital computing and sensors. Mention may be made, for example, of LiDARs, gas sensors, biosensors, etc. The active photonic components may be of any types, such as, for example, laser sources, photodiodes, N-to-P waveguide switches, Optical Phased Array (OPA), or phase or intensity modulators.

In integrated photonics, it is common to produce waveguides made of silicon, encapsulated with silica. A high refractive index contrast between silica and silicon makes it possible to produce compact photon circuits. These materials also make it possible to take advantage of existing infrastructures for the manufacture of CMOS circuits, namely large-diameter plates and high-resolution lithography equipment. It is also possible to exploit the semiconductor properties of silicon, possibly with the addition of germanium, to produce active photonic components.

However, silicon has a number of disadvantages. For example, it is not transparent for wavelengths less than 1.1 μm, it has no direct gap, and the active photonic components made of silicon are limited in frequency.

A particularly interesting alternative material is silicon nitride (SiₓN_{y}), also commonly used for the manufacture of CMOS circuits. A waveguide made of silicon nitride induces less propagation losses than a waveguide made of silicon, particularly when the silicon nitride is close to a stoichiometric composition (Si₃N₄). Unlike silicon, silicon nitride transmits light for wavelengths less than 1.1 μm (and typically ranging from 400 nm to 5 μm).

It is possible to exploit non-linear properties of silicon nitride to produce certain active photonic components (such as lasers), but it is preferable, and often indispensable, to use more suitable active materials. Among these, lithium niobate (LiNbO3), barium titanate (BaTiO3) or compounds formed of elements taken from columns III and V of the periodic table of elements have particularly interesting physical properties for producing high-performance photonic components, optically coupled to a photonic circuit including passive components, for example made of silicon or silicon nitride.

It is therefore necessary to optically couple a first waveguide, for example made of silicon or silicon nitride, with a second waveguide made of an active material different from that of the first waveguide. Standard manufacturing methods in the semiconductor industry require that the first and second waveguides be arranged in separate parallel planes.

In this configuration, and to limit coupling losses, it is known to optically couple a first optical mode and a second optical mode by an adiabatic coupling structure. The first and second optical modes have, respectively, a first and a second effective index, the first effective index being strictly greater than the second effective index. The first optical mode is guided by a first waveguide and the second optical mode is guided by a second waveguide. Respective optical axes of the first and second waveguides are aligned parallel to one another within the adiabatic coupling structure. A width of the first waveguide gradually narrows in a taper, so as to ensure optical coupling with the second waveguide. A functional coupling requires a fineness of the taper that requires the use of high-resolution lithography tools to achieve it, for example capable of resolving patterns with a dimension of less than 450 nm. In the context of an industrial application, these are only available on CMOS circuit manufacturing lines. However, some active materials are not permitted on these tools because they contain contaminants. It therefore appears that the choice of geometries and/or sizing and/or materials for the second waveguide is constrained by the value of the first effective index.

An example of an active photonic component including lithium niobate (LiNbO3) is described in T. Vanackere et al. “Heterogeneous integration of a high-speed lithium niobate modulator on silicon nitride using micro-transfer printing”, APL Photonics 8, 086102 (2023). Here, this is a modulator including two arms of a Mach-Zehnder interferometer. Each arm comprises two coupling structures between a first waveguide and a hybrid guide. The first waveguide includes a silicon nitride core that extends into a bonding section. The hybrid guide includes the bonding section and a lithium niobate base in contact with the bonding section.

A taper is etched at two opposite ends of lithium niobate portions. A lithium niobate portion is transferred on each bonding section, so as to center each taper on a respective bonding section. The base of each hybrid guide is a part of a lithium niobate portion. The hybrid guide is therefore butt-coupled with the first waveguide by the coupling structure, the tapers making it possible to limit diffraction losses at the coupling structure.

Electrodes are formed on the lithium niobate portions so as to apply an electrical field in an active region of each lithium niobate portion facing a silicon nitride bonding section. The electric field is capable of changing a refractive index of the active region by Pockels effect.

During operation, an incoming optical mode is equally separated into two intermediate optical modes guided by hybrid waveguides. At a hybrid waveguide, the intermediate optical mode is confined by the silicon nitride bonding section. Therefore, it does not fully interact with the active region, resulting in a loss of modulator efficiency. There is therefore a need to replace each coupling structure between the first guide and the hybrid guide with a coupling structure between the first guide and a second guide made entirely of lithium niobate.

Particular dimensions of the taper make it possible to minimize transmission losses induced by an alignment inaccuracy of the tapers of 0.5 μm (3σ) during the operation of transferring the lithium niobate sections, without however being fully satisfactory since an offset of 0.1 μm results in a transmission loss of 0.5 dB. These dimensions, around 100 nm, also imply the use of high-resolution lithography equipment, not available in an industrial production line accepting lithium niobate. An electron beam tool is used in this document, but such a tool provides a low production rate. Therefore, there is a need to replace each coupling structure with a coupling structure that is easier to produce and more robust to uncertainties of the manufacturing method.

### DISCLOSURE OF THE INVENTION

The object of the invention is to remedy at least partially the drawbacks of the prior art, and more particularly to propose a coupling structure for optically coupling a first optical mode having a first effective index and a second optical mode having a second effective index strictly greater than the first effective index, easy to perform, and that may be manufactured in high volume.

For this purpose, the object of the invention is a coupling structure for optically coupling a first optical mode having a first effective index and a second optical mode having a second effective index strictly greater than the first effective index. The coupling structure comprises a first waveguide including a core configured to guide the first optical mode, the core extending beyond the first waveguide in an extension comprising a proximal section, close to the first waveguide, and a distal section in contact with the proximal section. It comprises a second waveguide including a base and a ridge, configured to guide the second optical mode. It comprises a hybrid waveguide, interposed between the first and second waveguides, including the proximal section and an extension of the base beyond the second waveguide, arranged so as to cooperate to guide an intermediate optical mode optically coupled to the first optical mode by the extension. It comprises a modal transition section extending from the hybrid waveguide to the second waveguide, including the distal section.

The coupling structure is such that the proximal section has a width at a junction with the distal section such that an effective index of the intermediate optical mode is strictly greater than the second effective index. It is such that the distal section continuously narrows as it moves away from the hybrid waveguide so as to achieve optical coupling between the intermediate optical mode and the second optical mode.

Certain preferred but non-limiting aspects of this coupling structure are as follows.

The proximal section may be separated from the base extension by a dielectric interlayer portion. The interlayer portion may be made of silicon oxide or aluminum oxide.

The extension may further include a buffer section interposed between the first waveguide and the proximal section, the extension of the base may comprise a bevel facing the buffer section that may make an angle α less than or equal to 10° with an optical axis of the first waveguide, and that may extend on either side of the buffer section.

The angle α may be less than or equal to 8°. The buffer section may have a width between 1.3 μm and 2 μm. The interlayer portion may have a thickness S between 50 nm and 200 nm.

The core may be made of silicon nitride. The base may be made of lithium niobate, lithium tantalate, or barium titanate.

The ridge may be made of lithium niobate, lithium tantalate, barium titanate, silicon nitride, titanium oxide, tantalum oxide, silicon carbide, or silicon.

The ridge may have a width W₃₂₀ greater than or equal to 450 nm. The coupling structure may further comprise a substrate, the second waveguide may extend parallel to an upper face of the substrate and the ridge may have sidewalls which may have an angle less than or equal to 80° with respect to the upper face of the substrate.

The extension may have a height H_{2b} such that the effective index of any optical mode of the same wavelength and of the same polarization as the first optical mode, likely to propagate in the extension, may be strictly lower than the first effective index.

The invention also relates to an optical modulator including a coupling structure according to any one of the preceding features. The modulator may be a Mach-Zehnder modulator that may include two arms, an arm that may comprise a Pockels-effect tunable phase shifter, optically coupled to the second waveguide of the coupling structure by butt coupling.

The invention also relates to a method for manufacturing a coupling structure according to any one of the preceding features, including the following successive steps: providing a first assembly including a substrate, the core of the first waveguide and an upper optical confinement layer, such that the core extends over the substrate parallel to an upper face of the substrate, and the upper optical confinement layer encapsulates the core; transferring an active layer to the core and the upper optical confinement layer; forming the second waveguide in the active layer.

The upper optical confinement layer may have a bonding face that may cover the core, and that may be substantially parallel to the upper face. The transfer step may be a molecular bonding of the bonding face with a bonding layer in contact with the active layer. The interlayer portion may consist of a part of the upper optical confinement layer and a part of the bonding layer.

The upper optical confinement layer and the bonding layer may be made of silicon oxide. The active layer may be made of lithium niobate, lithium tantalate, or barium titanate.

### BRIEF DESCRIPTION OF THE DRAWINGS

Other aspects, aims, advantages and features of the invention will become more apparent upon reading the following detailed description of preferred embodiments thereof, provided by way of non-limiting example, and made with reference to the appended drawings wherein:

FIG. 1A is a schematic sectional view of a first embodiment of a coupling structure according to the invention;

FIG. 1B is a schematic view of the first embodiment along the section A-A of FIG. 1A;

FIG. 1C is a schematic view of the first embodiment along the section B-B of FIG. 1A;

FIG. 1D is a schematic view of the first embodiment along the section C-C of FIG. 1A;

FIG. 1E is a schematic view of the first embodiment along the section D-D of FIG. 1A;

FIG. 2A is a schematic top view of a second embodiment of a coupling structure according to the invention;

FIG. 2B is a schematic top view of a variant of the second embodiment;

FIG. 3 illustrates first simulation results useful for designing a coupling structure according to the invention;

FIG. 4 illustrates second simulation results useful for designing a coupling structure according to the invention;

FIGS. 5A, 5B and 5C illustrate third simulation results useful for designing a coupling structure according to the invention;

FIG. 6 is a schematic top view of a Mach-Zehnder modulator implementing coupling structures according to the variant of the second embodiment;

FIGS. 7A to 7F illustrate steps of a method for manufacturing a coupling structure according to the invention.

### DETAILED DISCLOSURE OF PARTICULAR EMBODIMENTS

In the figures and in the following description, the same references represent identical or similar elements. In addition, the different elements are not represented to scale so as to improve the clarity of the figures. Moreover, the different embodiments and alternatives are not mutually exclusive and could be combined together. Unless stated otherwise, the terms “substantially”, “about”, and “in the order of” mean within a 10% margin, and preferably within a 5% margin. Moreover, the terms “between . . . and . . . ” and equivalents mean that the bounds are included, unless specified otherwise.

The invention relates to a coupling structure comprising a first waveguide, a second waveguide and a hybrid waveguide interposed between the first waveguide and the second waveguide. Constraints impose that a first optical mode guided by the first waveguide has an effective index strictly lower than a second effective index of a second mode guided by the second waveguide. The constraints may be of any kind, for example a particular material for minimizing propagation losses for the first waveguide, particular dimensions for producing an active photonic component optically coupled to the second waveguide, an etching profile induced by an etching method used for producing the second waveguide, a material having a particular physical property for producing the second waveguide.

The first waveguide has a core that extends beyond the first waveguide in an extension that includes a proximal section and a distal section. The second waveguide is a ridge waveguide, i.e., it comprises a raised ridge above a base. The hybrid waveguide includes the proximal section and an extension of the base beyond the second waveguide. The proximal section and the extension of the base cooperate so as to guide an intermediate optical mode.

During operation, the intermediate optical mode is optically coupled to the first optical mode by the extension, and optically coupled to the second optical mode. The proximal section has a width greater than a minimum width beyond which the intermediate optical mode has an effective index strictly greater than the second effective index.

The coupling structure further comprises a modal transition section extending from the hybrid waveguide to the second waveguide, including the distal section. The modal transition section is such that the distal section continuously narrows as it moves away from the hybrid waveguide so as to gradually decrease the effective index of the intermediate optical mode to values below the second effective index and thus perform an optical coupling between the intermediate optical mode and the second optical mode.

Thus, it is possible to make an element of the first waveguide (the extension) and an element of the second waveguide (an extension of the base) cooperate to optically couple the first waveguide and the second waveguide, although the second effective index is strictly greater than the first effective index. In addition, the production of the second waveguide with the extension of the base thereof does not require a high-resolution lithography step. A lithography step is considered to be high resolution when it makes it possible to resolve patterns, for example a tip, the width of which is less than 450 nm, or even less than 250 nm.

Throughout the description, two optical components are said to be optically coupled if an optical mode can at least partly propagate in the two optical components, optionally via intermediate optical components. Two guided optical modes are said to be optically coupled when the power of one is derived entirely from the power of the other, without intermediate conversion into another form of energy.

The invention is particularly advantageous for coupling a first waveguide made of silicon nitride with a second waveguide made of lithium niobate. Indeed, a plurality of factors imply that the effective index of an optical mode guided by the second waveguide is strictly greater than the effective index of an optical mode guided by the first waveguide. In particular, silicon nitride has a refractive index lower than a refractive index of lithium niobate. A sufficient thickness of lithium niobate is required to produce an active photonic component, for example between 300 nm and 800 nm. An etching method for forming the second waveguide leads to obtaining a second waveguide comprising inclined sidewalls.

Throughout the description, a waveguide is a single-mode or multi-mode waveguide capable of confining light, as opposed to optical guides within which light propagates by total internal reflection. Without further clarification, a waveguide can be of any type. It can be, for example, a strip, ridge or planar guide. A waveguide has a core and, optionally, one or more confinement layers surrounding the core so as to be in physical contact with the core. A contrast or variation in refractive indices between the core on the one hand and the confinement layer(s) or a gas or vacuum on the other hand, makes it possible to confine light. The waveguides are referenced by the cores thereof in the figures. Similarly, without further precision, a refractive index of a waveguide is a refractive index of the core of the waveguide; a distance separating two waveguides is the distance separating the cores of the respective waveguides; the material of a waveguide is the material of the core of the waveguide; when a waveguide extends in a direction, it is understood that the core of the waveguide extends in that direction; when a waveguide is in contact with a layer, it is understood that the core of the waveguide is in contact with the layer.

Throughout the description, “effective index” is given the common meaning thereof in the technical field. For the sake of clarity, however, it is specified that the effective index of an optical mode guided by a waveguide is the scalar quantity equal to the refractive index of a fictitious homogeneous medium within which a light wave of the same wavelength as the guided mode would propagate in free space at the same phase speed as the guided mode in the waveguide. The effective index depends in particular on the geometry of the waveguide and the materials making it up. It may be determined by simulation.

Layer means an area consisting of one or more sublayers of a material of which the thickness along a z-axis is less than, for example ten times, or even twenty times, the longitudinal width and length dimensions thereof in a plane (x, y) perpendicular to the z-axis. A layer may be structured, or a structure of substantially constant thickness extending predominantly in a main plane. When it consists of a plurality of sublayers, the sublayers may be made from different materials. The sublayer or sublayers extend in planes substantially parallel to the plane (x, y). When a layer has a property, it is understood that when it consists of a plurality of sublayers, all sublayers have the same property, unless explicitly stated otherwise. By way of example, in the absence of more precision, a layer of metal or of a semiconductor or amorphous material may comprise a plurality of sublayers, all respectively made of metal, of a semiconductor or of an amorphous material. A layer may be conformal, which implies that it extends over a surface, for example non-planar, and that it hugs this surface.

Particular embodiments will be described relating to a coupling structure between a first strip-type waveguide and a second ridge waveguide. However, these embodiments may be adapted to a first waveguide and/or a second waveguide of another type, for example a first ridge waveguide, and/or a second planar waveguide.

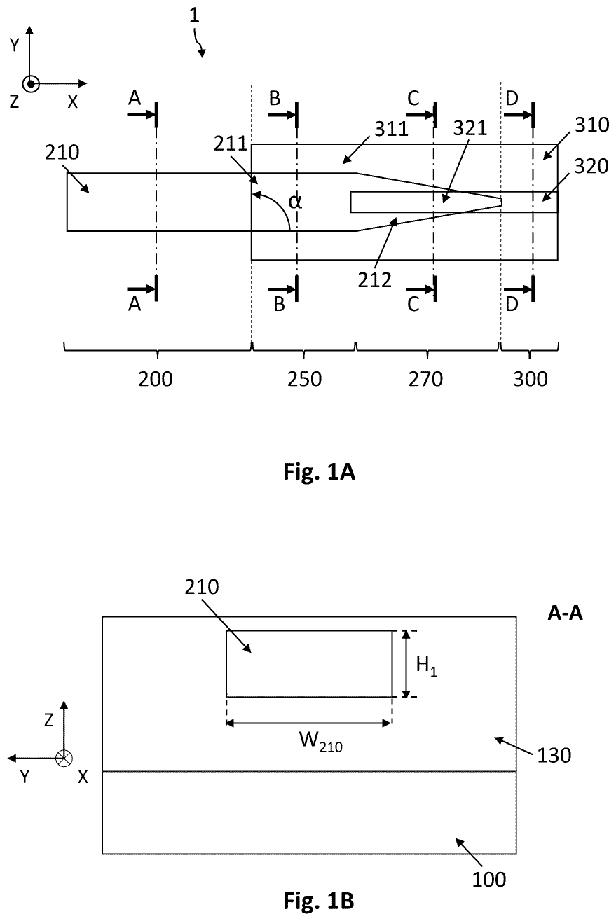

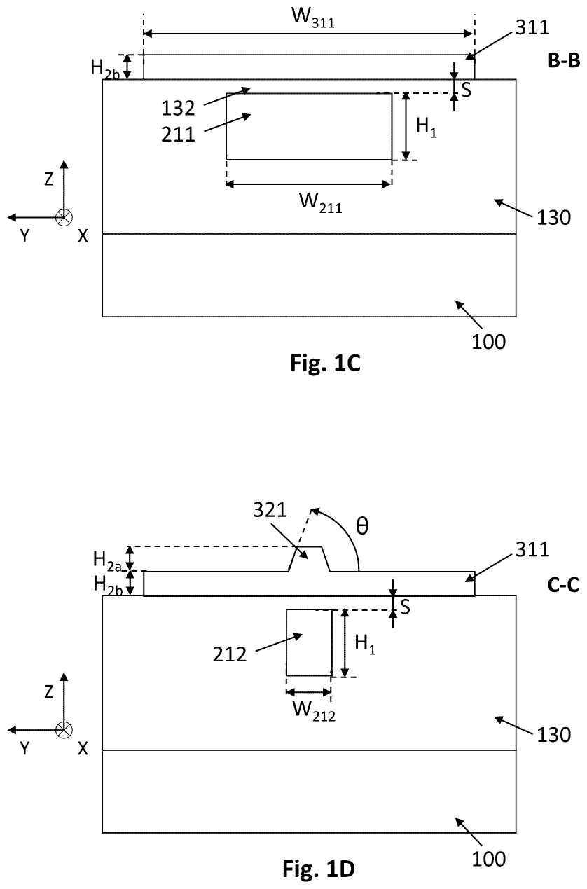

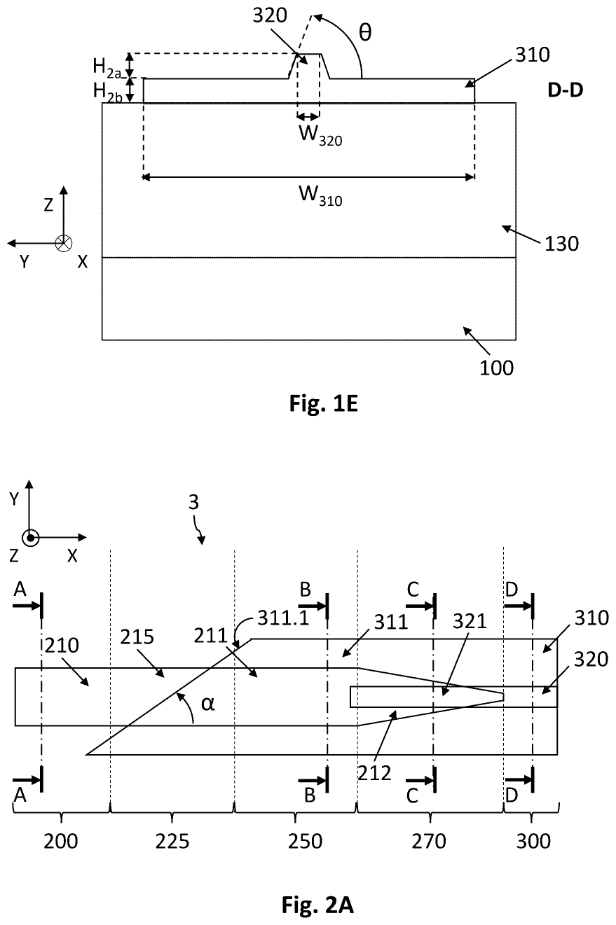

Firstly, a first embodiment of an extraction structure 1 according to the invention will be described in relation to FIGS. 1A and 1E. FIG. 1A is a top view on which only certain elements have been shown. FIGS. 1B to 1E are views according to the respective sections A-A, B-B, C-C and D-D, shown in FIG. 1A.

The coupling structure 1 is intended to optically couple a first optical mode having a first effective index and a second optical mode having a second effective index strictly greater than the first effective index. The first and second optical modes have the same wavelength λ.

The coupling structure 1 includes a substrate 100, a first waveguide 200, a hybrid waveguide 250, a modal transition section 270, and a second waveguide 300. The substrate 100 has a substantially flat upper face. The first waveguide 200, the hybrid waveguide 250, the modal transition section 270 and the second waveguide 300 successively extend over the substrate 100, along an optical axis oriented from the first waveguide 200 to the second waveguide 300, in planes substantially parallel to the upper face, located on the same side of the substrate 100 as the upper face.

Here and for the remainder of the description, an orthogonal three-dimensional direct reference point (X, Y, Z) is defined, where the X and Y axes form a plane parallel to the upper face of the substrate 100, the X-axis being oriented in the optical axis, and where the Z-axis is oriented substantially orthogonally to the upper face of the substrate 100, from the upper face to the first waveguide 200. In the following description, the terms “vertical” and “vertically” are defined as relating to an orientation substantially parallel to the Z-axis, and the terms “horizontal” and “horizontally” as relating to an orientation substantially parallel to the plane (X, Y). Moreover, the terms “lower” and “upper” are defined as relating to an increasing position when moving away from the substrate 100 in the +Z direction. The term “lateral” refers to an orientation substantially parallel to the Z-axis.

The substrate 100 may be derived from a silicon plate, after any cutting and/or thinning steps. An optical confinement layer 130 extends over the substrate 100 so as to be in contact with the upper face of the substrate 100. The optical confinement layer 130 has an upper face on one side of the optical confinement layer 130 opposite the substrate 100. The upper face of the optical confinement layer 130 is substantially flat and parallel to the upper face of the substrate 100.

The optical confinement layer 130 is made of one or more transparent materials at the wavelength λ, for example made of a semiconductor material or a dielectric material. It may for example consist of a lower sublayer in contact with the substrate 100 and one or more bonding sublayers in contact with the lower sublayer. The lower sublayer may for example be made of silicon oxide. The optical confinement layer 130 may include one or two bonding sublayers, for example made of silicon nitride or aluminum oxide, optionally including a bonding interface. The optical confinement layer 130 is here made of silicon oxide.

The first waveguide 200 comprises a core 210 (FIG. 1B). The core 210 extends into the optical confinement layer 130, parallel to the optical axis and to the upper face of the substrate 100. It may be flush with the upper face of the optical confinement layer 130, or, as shown here, be surrounded from all sides by the optical confinement layer 130. In this example, the core 210 has a rectangular section in any plane of section parallel to the plane (Y, Z). It has a width W₂₁₀ measured parallel to the Y-axis, and a height H₁ measured parallel to the Z-axis. The section of the core 210 may have any shape making it possible to propagate an optical mode in the first waveguide 200.

The core 210 has a refractive index strictly greater than a refractive index of the optical confinement layer 130. Here it is made of silicon oxide. Alternatively, it may be made of silicon, silicon carbide, aluminum nitride, titanium oxide, tantalum oxide, diamond, or a gallium nitride-based compound.

The core 210 extends beyond the first waveguide 200, in the +X direction, in an extension. The extension comprises a proximal section 211, followed by a distal section 212. The proximal section 211 is in contact with the first waveguide 200 and the distal section 212 is in contact with the proximal section 211. The core 210, the proximal section 211 and the distal section 212 are made of the same material. The proximal section 211, respectively distal 212, has a width W₂₁₁, respectively W₂₁₂, measured parallel to the Y-axis. The proximal and distal sections 211, 212 have a constant height equal to H₁, measured parallel to the Z-axis. The widths W₂₁₁ and W₂₁₂ may vary along the X-axis.

The second waveguide 300 comprises a base 310 and a ridge 320. The base 310 extends over the optical confinement layer 130 so as to be in contact with the upper face of the optical confinement layer 130. It has a width W₃₁₀ measured parallel to the Y-axis, and a height H_{2b} measured parallel to the Z-axis. The height H_{2b} is substantially constant. The base 310 here has a rectangular section in any sectional plane parallel to the plane (Y, Z).

The ridge 320 is a raised part relative to the base 310. It extends over the base 310 parallel to the optical axis and the X-axis, on one side of the base 310 opposite the optical confinement layer 130. It has sidewalls forming an angle θ with the plane (X, Y). The angle θ is for example between 40° and 90°, or between 40° and 80°, or between 40° and 70°, or substantially equal to 50° or 60°. It extends vertically from the base 310 over a height H₂ₐ measured parallel to the Z-axis. It has a width W₃₂₀ measured parallel to the Y-axis, at an upper face of the ridge 320. The height H₂ₐ is constant here.

The ridge 320 and the base 310 are for example made of the same transparent material at the wavelength λ. The material may for example be a material having a physical property enabling the fabrication of an active photonic component, such as a semiconductor material and/or a piezoelectric material and/or a second-order or third-order non-linear optical material. The ridge 320 and the base 310 are here made of lithium niobate (LiNbO3). For example, they may also be made of barium titanate (BaTiO3), lithium tantalate (LaTiO₃), or perovskite.

Alternatively, the ridge 320 and the base 310 may be made of different materials. The ridge 320 may for example be made of silicon nitride, titanium oxide, tantalum oxide, silicon carbide, silicon, chalcogenide or any transparent semiconductor or dielectric material at the wavelength of the first and second optical modes. The base 310 may be made of lithium niobate, barium titanate, lithium tantalate, or another perovskite-type material.

The hybrid waveguide 250 includes the proximal section 211 and a distal portion of an extension 311 of the base 310 facing the proximal section 211. The extension 311 of the base 310 extends over the optical confinement layer 130, so as to be in contact with the upper face of the optical confinement layer 130, in the direction of the first waveguide 200, from the second waveguide 300 to a distal edge 311.1 of the extension 311. The distal edge 311.1 is an edge of the extension 311, straight in this example. It delimits an angle α with the optical axis and the X-axis, in the plane (X, Y). The angle α is equal to 90°.

The distal portion of the extension 311 has a width W₃₁₁ measured parallel to the Y-axis. The width W₃₁₁ is strictly greater than W₂₁₁. Preferably, W₃₁₁ is greater than or equal to 10*λ/n₂₁₁, where n₂₁₁ is the refractive index of the proximal section 211. The width W₃₁₁ is here constant along the X-axis, equal to the width W₃₁₀.

When the core 210 is flush with the upper face of the optical confinement layer 130, the extension 311 of the base 310 is in contact with the proximal section 211. Advantageously, as shown in FIG. 1C, the proximal section 211 is separated from the extension 311 by an interlayer portion 132. The interlayer portion 132 is a part of the optical confinement layer 130 in contact with the proximal section 211 and the extension 311. It has a thickness S measured parallel to the Z-axis.

The modal transition section 270 (FIG. 1D) extends along the X-axis, from the hybrid waveguide 250 to the second waveguide 300. It includes the distal section 212 and a proximal portion of the extension 311 of the base 310, facing the distal section 212. The width W₂₁₂ gradually decreases, for example linearly, along the oriented +X axis. The proximal and distal sections 211, 212 have for example the same width at the junction thereof, as shown in FIG. 1A. Advantageously, as shown in FIG. 1A, the modal transition section 270 may include an extension 321 of the ridge 320 extending over the extension 311 of the base 310 toward the first waveguide 200. Preferably, the extension 321 of the ridge 320 extends over the entire proximal portion of the extension 311, and optionally over a part of the distal portion of the extension 311. Thus, diffraction losses may be avoided. The extension 321 here has a height equal to H₂ₐ over the entire length thereof.

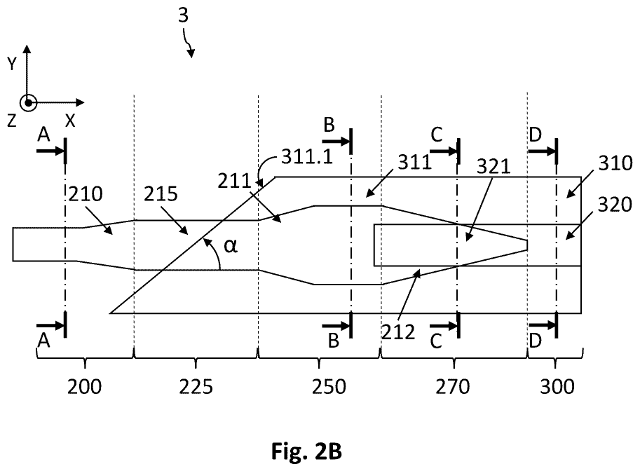

A second embodiment of a coupling structure 2 according to the invention will now be described in relation to FIG. 2A. Only the differences with the first embodiment are explicitly disclosed. FIGS. 1B, 1C, 1D, 1E are also views according to the sections A-A, B-B, C-C and D-D of FIG. 2A.

For this embodiment, the coupling structure 2 further includes a modal adaptation section 225. The core 210 extends beyond the first waveguide 200, in the +X direction, in an extension including a buffer section 215, a proximal section 211, followed by a distal section 212. The proximal section 211 is interposed between the buffer section 215 and the distal section 212 and in contact therewith. The buffer section 215 is in contact with the first waveguide 200. The core 210, the buffer section 215, the proximal section 211 and the distal section 212 are made of the same material. The buffer section 215 has a width W₂₁₅ measured parallel to the Y-axis, here substantially constant. The width W₂₁₅ may be equal to the width W₂₁₁ at the junction of the proximal section 211 with the buffer section 215, as shown here. It has a constant height equal to H₁, measured parallel to the Z-axis. In all embodiments, the widths W₂₁₀, W₂₁₁, W₂₁₂ and W₂₁₅ are measured in the same plane parallel to the plane (X, Y), for example at a lower face of the corresponding sections.

The modal adaptation section 225 comprises the buffer section 215 and an end of the extension 311 of the base 310, facing the buffer section 215. The end of the extension 311 is a continuation of the distal portion of the extension 311 that includes the distal edge 311.1. In this example, the distal edge 311.1 has a substantially straight segment facing the buffer section 215. Preferably, the segment extends sufficiently in length, on either side of the buffer section 215 in a plane parallel to the plane (X, Y) to compensate for a resolution limit of the extension 311 and/or an alignment uncertainty of the extension 311 relative to the buffer section 215, when forming the extension 311 of the base 310. For an alignment uncertainty of 300 nm, typical of lithography equipment available on a production line of Micro-Electro-Mechanical Systems (or MEMS), the segment of the distal edge 311.1 may be centered on the buffer section 215 and have a length between 30 μm and 500 μm, for example equal to 300 μm. The angle α may be between 4° and 8°. The segment may have other shapes making it possible to limit diffraction losses when passing the distal edge 311.1.

The end of the extension 311 has for example a width equal to W₃₁₁, measured parallel to the Y-axis. The angle α is an acute angle, for example between 2° and 10°, preferably between 4° and 8°. Thus, the distal edge 311.1 is a beveled edge, or a bevel, of the extension 311 of the base 310 making it possible to minimize transmission losses. In order to minimize these transmission losses, W₂₁₅, α and S can be optimized together, for example, using a simulation tool.

A variant of the second embodiment will now be described in relation to FIG. 2B. Only the differences with the second embodiment are explicitly disclosed. FIGS. 1B, 1C, 1D, 1E are also views according to the sections A-A, B-B, C-C and D-D of FIG. 2A.

Here, the width W₂₁₁ is a montonically increasing function of X, moving away from the buffer section 215. The width W₂₁₅ is substantially constant and equal to the minimum value of W₂₁₁. The width W₂₁₀ of the core 210 is equal to the width W₂₁₅ at the junction between the core 210 and the buffer section 215. Here, W₂₁₀ is a monotonically increasing function of X, approaching the buffer section 215. The width W₂₁₂ of the distal section 212 is equal to the maximum value of W₂₁₁ at the junction between the distal section 212 and the proximal section 211.

Now, an example of operation of the coupling structure 1, 2, 3 will be described for optically coupling a first optical mode propagating in the first waveguide 200 to a second optical mode propagating in the second waveguide 300, it being understood that the coupling structure 2 operates in the same manner to couple the second optical mode to the first optical mode by application of the optical reciprocity principle. The first optical mode has a first effective index. The second optical mode has a second effective index strictly greater than the first effective index. Here, the first and second optical modes have a transverse-electric (TE) type polarization.

In this example, dimensions are given in relation to special conditions. More specifically, the wavelength λ is equal to 1,550 nm, the core 210 is made of silicon nitride and the second waveguide 300 is made of lithium niobate. The height H₁ may not exceed a maximum height H_{1,max} imposed by mechanical stresses induced by silicon nitride. It is also at 800 nm.

The heights H_{2b} and H₂ₐ are here sufficiently large to produce at least a part of an active photonic component and the second waveguide 300 in a same lithium niobate layer. The sum of the heights H₂ₐ and H_{2b} is for example between 300 nm and 1 μm. The height H_{2b} may for example be between 150 nm and 500 nm. In this example, the heights H₂ₐ and H_{2b} are equal to 300 nm. The second effective index increases when H₂ₐ and/or H_{2b} increase.

In this example, θ has a value strictly less than 90° imposed by an etching step used for the formation of the second waveguide 300. The second effective index increases when θ decreases. In this example, θ is equal to 50°.

The first optical mode is confined by the core 210 and propagates toward the proximal section 211. It reaches a first transition zone when it reaches the distal edge 311.1. Diffraction losses induced by the distal edge 311.1 are minimized by optimizing the confinement of the first optical mode inside the core 210 and by keeping the first optical mode away from the distal edge 311.1. Thus, the greater the thickness S, the lower the diffraction losses.

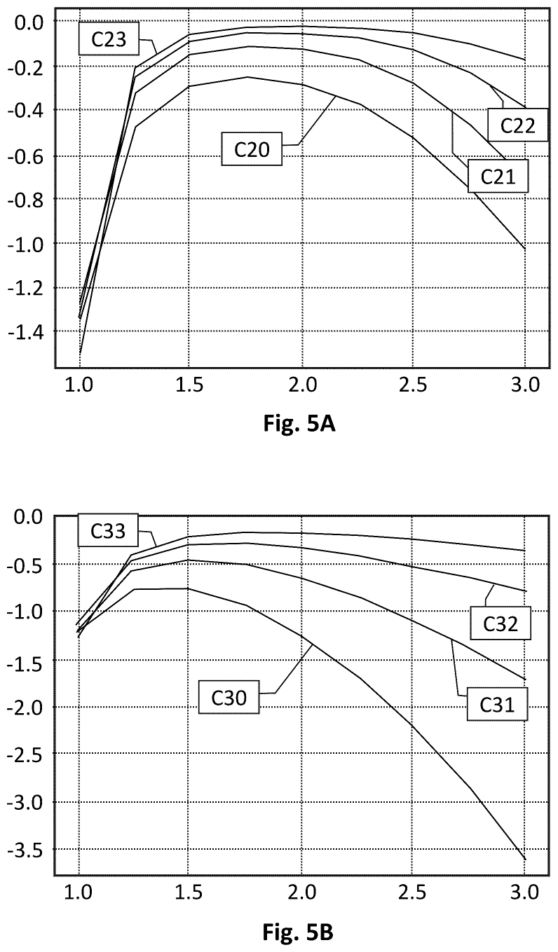

FIGS. 5A to 5C show simulation results giving the transmission loss (y-axis, in dB) between the first optical mode and an intermediate optical mode guided by the hybrid waveguide 250, as a function of the width W₂₁₅ (x-axes, in μm). In FIG. 5A, the transmission losses are given for an angle α equal to 4° and for a thickness S equal to 50 nm (curve C20), at 100 nm (curve C21), at 150 nm (curve C22), and at 200 nm (curve C23). In FIG. 5B, the transmission losses are given for an angle α equal to 8° and for a thickness S equal to 50 nm (curve C30), at 100 nm (curve C31), at 150 nm (curve C32), and at 200 nm (curve C33). In FIG. 5C, the transmission losses are given for an angle α equal to 30° and for a thickness S equal to 50 nm (curve C40), at 100 nm (curve C41), at 150 nm (curve C42), and at 200 nm (curve C43).

Surprisingly, the transmission loss between the first optical mode and the intermediate optical mode is not a monotonous function of W₂₁₅ as soon as the angle α is less than or equal to 10°. For an angle α between 4° and 8°, the transmission losses between the first optical mode and the intermediate optical mode are minimal for a width W₂₁₅ between 1.3 μm and 2 μm, the transmission losses being the lower as S increases, here from 50 nm to 200 nm. By way of example, for an angle α equal to 4° and a thickness S equal to 100 nm, the transmission losses reach a minimum for a width W₂₁₅ equal to 1.75 μm.

In all embodiments, the height H_{2b} is further preferably low enough for the first optical mode not to excite an optical mode competing with the intermediate optical mode, guided by the extension 311 of the base 310. This result is in particular achieved for an extension 311 of any height H_{2b}, less than or equal to a value H_{2b,max}, as soon as the effective index of any optical mode of the same wavelength and of the same polarization as the first optical mode, likely to propagate in the extension 311, is strictly lower than the first effective index. The H_{2b,max} value can for example be determined by simulation.

Upon passing the first transition zone, the first optical mode transfers the energy to the intermediate optical mode guided by the hybrid waveguide 250. The width W₂₁₁ at the junction between the proximal section 211 and the distal section 212 is greater than a minimum width W_{211,min} beyond which the effective index of the intermediate optical mode is greater than or equal to the second effective index. Thus, it is possible to transfer energy from the intermediate optical mode to the second optical mode by the modal transition section 270.

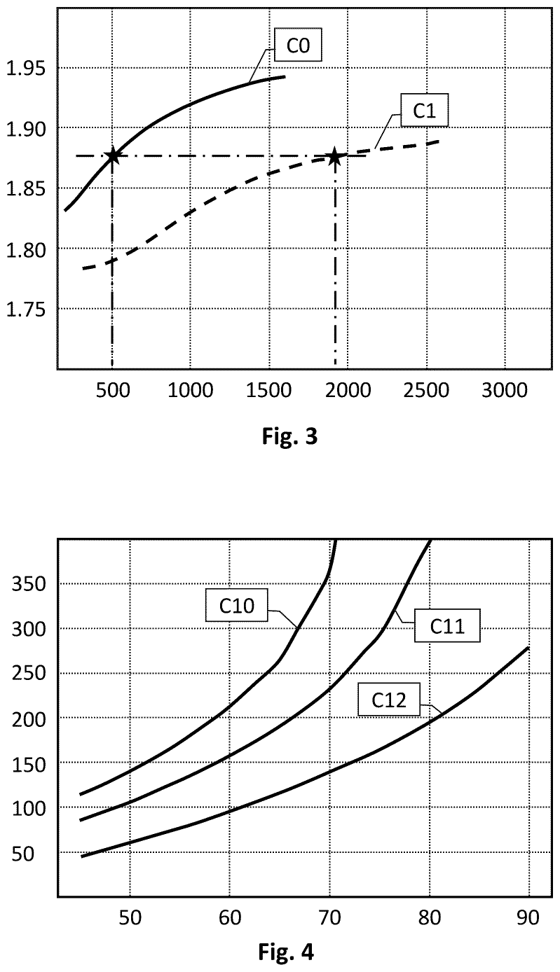

FIG. 3 shows simulation results giving the effective index of the second optical mode as a function of the width W₃₂₀ (x-axis in nm) of the ridge 320 (curve C0) and the effective index of the intermediate optical mode as a function of the width W₂₁₁ (x-axis in nm) of the proximal section 211, for a thickness S equal to 100 nm. Stars mark dimensions of this example. For this, the width W₃₂₀ of the ridge 320 is chosen to be greater than or equal to 450 nm, at the resolution limit of a lithography equipment available on a production line mainly adapted to the production of MEMS. Such a production line is adapted to receive lithium niobate, barium titanate, or lithium tantalate. The width W₃₂₀ here is equal to 500 nm.

From FIG. 3, it is noted that W_{211,min} is equal to 1,900 nm. W2₁₁ is therefore chosen strictly greater than 1.9 μm, for example in a range between 2 μm and 3 μm.

It was observed that the minimum width W_{211,min} increases when the thickness S increases and/or when e decreases. FIG. 4 shows simulation results giving the maximum value Sₘₐₓ of the thickness S (y-axis, in nm) below which the effective index of the intermediate optical mode is strictly greater than the second effective index, as a function of θ (x-axis, in degrees), for a width W₂₁₁ at the junction between the proximal section 211 and the distal section 212, equal to 2.5 μm (curve C10), 2.0 μm (curve C11) and 1.5 μm (curve C12).

The thickness S is chosen as large as possible to minimize the transmission losses when passing the first transition, while remaining below an upper limit Sₛᵤₚ less than or equal to Sₘₐₓ, making it possible, for example, to ensure that the thicknesses S of a plurality of coupling structures 1 are less than or equal to Sₘₐₓ despite the uncertainties of a manufacturing process. In this example, the width W₂₁₁ is chosen equal to 2.5 μm and S equal to 100 nm.

The intermediate optical mode subsequently reaches the modal transition section 270. At the junction between the proximal section 211 and the distal section 212, the width W₂₁₂ is equal to the width W₂₁₁. The width W₂₁₂ gradually decreases in a monotonic manner, for example linearly, in the direction of the second waveguide 300, to cause the effective index of the intermediate optical mode to decrease until reaching and exceeding the second effective index. Thus, a part of the power of the intermediate optical mode is transferred to the second optical mode. The extension 321 of the ridge 320 extends from the second waveguide 300 at least to the point where the effective index of the intermediate optical mode is equal to the second effective index. In this example, the width W₂₁₂ decreases until reaching the value of 200 nm, over a length between 10 μm and 50 μm measured along the +X axis. The distal section 212 can be formed using equipment of a CMOS production line, since silicon nitride is a common material on this type of production lines.

The modal transition section 270 makes it possible to transfer the power from the intermediate optical mode to the second optical mode with a loss of less than 1 dB for the thickness S equal to 100 nm of this example. A decrease in the thickness S makes it possible to decrease the transmission losses when passing the modal transition section 270, up to values less than or equal to 0.5 dB with the parameters and materials of this example.

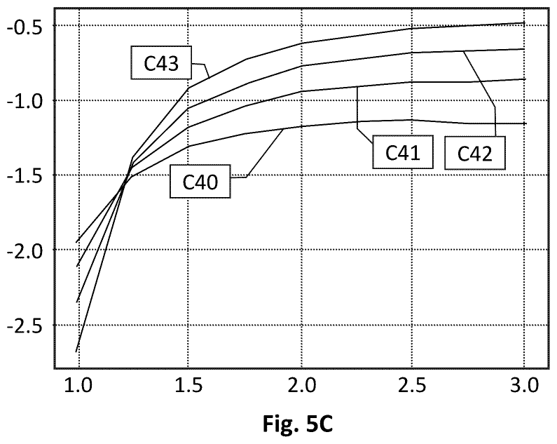

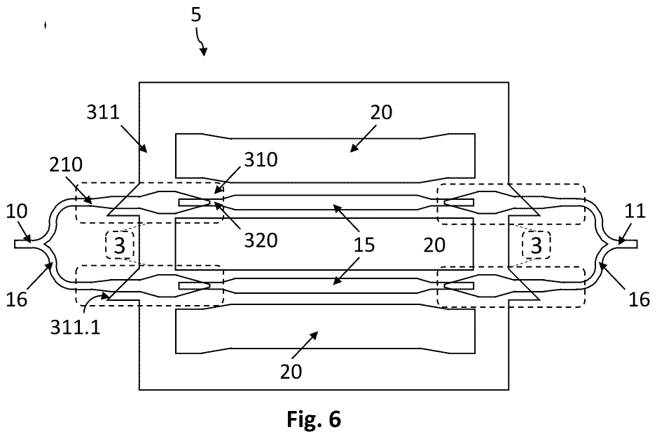

In relation to FIG. 6, a Mach-Zehnder modulator 5 implementing coupling structures 3 according to the variant of the second embodiment is now described. It is likely to operate at frequencies equal to or above 50 GHz. The coupling structures 3 are marked by dashed rectangles in this figure. However, one or more of the coupling structures thereof may be replaced by a coupling structure 1, 2 according to the first or second embodiment.

The Mach-Zehnder modulator 5 comprises two arms 15. At least one arm includes a controllable phase shifter, capable of applying a phase shift to an optical mode guided by the phase shifter relative to an optical mode guided by the other arm 15, according to an input signal. Phase shifting may be applied by any known means, for example by injection of charge carriers, or by using a Pockels effect induced by an electrical field or mechanical stress to obtain a non-centrosymmetric mesh. The input signal acts on the phase shifter via electrodes. In the case of Pockels-effect operation, the electrodes apply the electric field to the phase shifter in order to change the refractive index thereof.

In this example, each arm includes two coupling structures 3 arranged at two ends of the arm 15 and a phase shifter optically coupled to each coupling structure 3 of the arm. The Mach-Zehnder modulator 5 further comprises an input 10 and an output 11. The input 10 and the output 11 are each optically coupled to each of the arms 15 by a separate Y-junction 16 of the Mach-Zehnder modulator 5. Here, for each coupling structure 3, the first waveguide is made of silicon nitride. Each Y-junction is made of silicon nitride. For each coupling structure 3, the first waveguide is optically coupled to an end of a corresponding Y-junction, here by butt coupling.

The bases 310 and the extensions 311 of the four coupling structures 3 are parts of a common layer. Each phase shifter is a ridge waveguide. It comprises a ridge that is a raised part of the common layer. The ridge of each phase shifter extends the ridge 320 of the second waveguide of each coupling structure 3 to which the phase shifter is optically coupled. Thus, each phase shifter is optically coupled to two coupling structures 3 by butt coupling. In this example, the phase shifters all have the same geometric dimensions. The ridges 320 of the coupling structures 3 and the phase shifters are parts of the common layer. Here, all of the coupling structures 3 have all the geometrical dimensions thereof equal. They are made of the same materials.

The common layer is here a second-order non-linear optical material, for example lithium niobate. The Mach-Zehnder modulator 5 further comprises electrodes 20 resting on the common layer. Two electrodes 20 are arranged on either side of each arm 15, so as to apply an electrical field modifying a refractive index of each phase shifter by Pockels effect when a difference in electrical potential is applied to the terminals thereof. In this example, the Mach-Zehnder modulator 5 may be biased in “push-pull” mode, according to terminology commonly employed in the technical field, so that the electrical field is of opposite direction in the two arms of the modulator.

The electrodes 20 consist of a central electrode and two outer electrodes. The central electrode extends over the common layer between the two phase shifters of the Mach-Zehnder modulator 5, parallel to the latter. Each outer electrode extends over the common layer parallel to a phase shifter, on one side of the corresponding arm 15, opposite the central electrode.

For example, the outer electrodes each have a width at least equal to 100 μm. The central electrode here has a fixed width of 10 μm. The distance separating the central electrode from an external electrode is for example equal to 5 μm. The electrodes may be made of metal, for example aluminum and/or chrome.

The ridge of each phase shifter has a width Wm making it possible to reduce propagation losses. For example, the width Wₘ is strictly greater than the width W₃₂₀ of the ridges 320 of all coupling structures 3. It may be strictly greater than a width W_{320,max} of the ridge 320 beyond which it is not possible to obtain an effective index of the intermediate optical mode strictly greater than the second effective index for all values of the width W₂₁₁. The greater the width Wₘ, the lower the propagation losses. The effectiveness of a phase shift per unit of length applied to an optical mode guided by the phase shifter depends on a plurality of parameters including the width Wₘ, and the heights H₂ₐ, H_{2b}. Depending on the applications, a compromise on the value of Wₘ may be sought to obtain desired propagation losses and phase shifting efficiency. By way of example, for heights H₂ₐ, H_{2b} both equal to 300 nm, the width Wₘ may be chosen greater than or equal to 750 nm, preferably substantially equal to 1.15 μm. Each phase shifter extends between two coupling structures 3 over a length between 2 mm and 1 cm, for example equal to 5 mm.

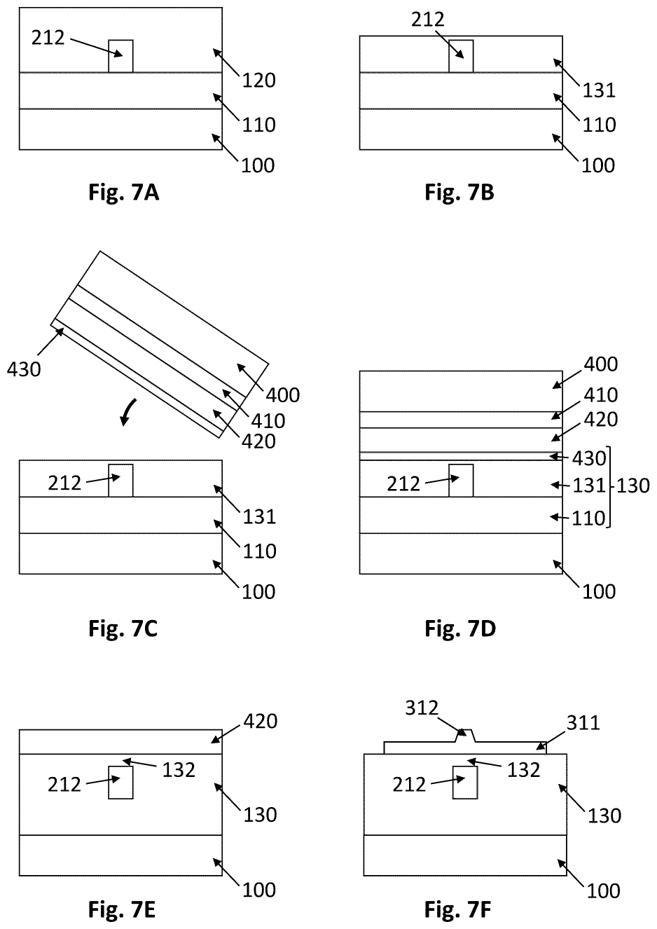

An example method for producing a coupling structure 1, 2, 33 as illustrated in FIGS. 7A to 7F is now described. FIGS. 7A to 7F are views according to the section C-C of FIGS. 1A, 2A and 2B.

In FIG. 7A, a first assembly is provided including the substrate 100, a lower optical confinement layer 110, the core 210, the extension of the core 210 that comprises the proximal section 211, the distal section 212, and optionally the buffer section 215. The core 210 and the extension of the core 210 may be a part of a structured layer including passive photonic components. The structured layer may be obtained by a deposition step, for example Low Pressure Chemical Vapor Deposition (LPCVD), Physical Vapor Deposition (PVD) or Plasma Enhanced Chemical Vapor Deposition (PECVD), followed by one or more lithographic etching substeps, for example by means of equipment available on a production line of CMOS circuits. The structured layer is here made of silicon nitride.

The lower optical confinement layer 110 rests on the upper face of the substrate 100, in contact with the latter. An encapsulation layer 120 is deposited on the lower optical confinement layer 110 and on the structured layer, so as to encapsulate the core 210 and the extension of the core 210. The lower optical confinement layer 110 and the encapsulation layer 120 are for example made of silicon oxide resulting from a PVD or PECVD deposition.

Alternatively, the structured layer may have been formed by a damascene-type method after a deposition of at least one part of the encapsulation layer 120.

In FIG. 7B, the encapsulation layer 120 is thinned, for example by a Chemical Mechanical Polishing (CMP) substep. The residual part of the encapsulation layer 120 constitutes an upper optical confinement layer 131. The upper optical confinement layer 131 has a bonding face on one side of the upper optical confinement layer 131 opposite the substrate 100. Preferably, the bonding face of the upper optical confinement layer 131 covers the core 210 and the extension of the core 210, as shown in FIG. 7B. The bonding face has properties of flatness, roughness and chemical compatibility enabling bonding, in particular molecular bonding possible.

The upper optical confinement layer 131 may comprise an optional bonding sublayer deposited after thinning the encapsulation layer 120. This may be an aluminum oxide backing or a Benzo Cyclo Butene (BCB) polymer layer. It may be deposited by an Atomic Layer Deposition (ALD) or Ion Beam Assisted Deposition (IBAD) technique or by spin coating.

In FIG. 7C, a second assembly including a temporary substrate 400, a buried layer 410 and an active layer 420 is provided. The buried layer 410 is interposed between the temporary substrate 400 and the active layer 420. It is in contact with the temporary substrate 400 and the active layer 420. The active layer 420 may be made of lithium niobate or barium titanate. The buried layer 410 is made of a material capable of being etched selectively with respect to the active layer 420. The buried layer 410 is here made of silicon oxide. The temporary substrate 400 may be made of silicon, quartz, silica glass, or lithium niobate. Here, the active layer 420 is made of lithium niobate, the buried layer 410 is made of silicon oxide, and the temporary substrate 400 is made of silicon.

A bonding layer 430 is deposited on the active layer 420. During a bonding substep, the bonding face of the upper optical confinement layer 131 is subsequently brought into contact with the bonding layer 430, after any surface treatments, so as to bond the first assembly onto the second assembly. The bonding layer 430 is for example a layer made of silicon oxide or aluminum oxide. The bonding substep may be an oxide-oxide or alumina-alumina bonding. It may be a hydrophilic molecular bond.

In FIG. 7D, a possible heat treatment is carried out to reinforce a bonding interface between the bonding layer 430 and the upper optical confinement layer 131. The optical confinement layer 130 consists of the lower optical confinement layer 110, the upper optical confinement layer 131 and the bonding layer 430. The interlayer portion 132 consists of a part of the upper optical confinement layer 131 and a part of the bonding layer 430. It may include a residual bonding interface between the upper optical confinement layer 131 and the bonding layer 430, the upper optical confinement layer 131 may include a bonding sublayer in contact with the bonding layer 430. In the case of molecular bonding, the bonding interface may be closed, that is to say it includes only covalent bonds between the upper optical confinement layer 131 and the bonding layer 430.

In FIG. 7E, the temporary substrate 400 is removed by one or more substeps of honing and/or polishing and/or etching, for example chemical, where applicable the etching may implement a tetramethylammonium hydroxide (TMAH) solution. The buried layer 410 is subsequently removed by selective etching with respect to the active layer 420. In this example of method, selective etching implements a hydrofluoric acid (HF) solution.

Optionally, in particular when the temporary substrate 400 has a dimension smaller than a dimension of the substrate 100, a protective thin layer is conformally deposited on the optical confinement layer 130 and the temporary substrate 400, between the step of FIG. 7D and the step of FIG. 7E. The part of the thin layer in contact with the temporary substrate 400 is removed with the temporary substrate 400 during the substep of removing the temporary substrate 400. The protective thin layer is made of a selective etch resistant material used to remove the buried layer 410. The protective thin layer may be made of silicon nitride.

In FIG. 7F, the second waveguide 300 is formed in the active layer 420, for example using one or more lithographic equipment having a resolution limit greater than or equal to 450 nm, available in a MEMS production line. The base 310, the extension 311 of the base 310 and the ridge 320 are for example formed by Ion Beam Etching (IBE) or Reactive Ion Etching (RIE), based on argon ions. The base 310, the extension 311 of the base 310 and the ridge 320 may then have sidewalls making an angle with the upper face of the substrate 100 between 40° and 90°, or between 40° and 80°, or between 40° and 80°, or substantially equal to 50°.

Particular embodiments have just been described. Different alternatives and modifications will become apparent to the person skilled in the art. For example, it is possible to encapsulate the modal adaptation section 225 and/or the hybrid waveguide 250 and/or the modal transition section 270 and/or the second waveguide 300 by an additional encapsulation layer resting on the optical confinement layer 130, on the base 310 and/or the extension 311 of the base 310 and/or the ridge 320. The additional encapsulation layer is then transparent at the λ wavelength and has a refractive index making a light confinement function possible.

1. A coupling structure for optically coupling a first optical mode having a first effective index and a second optical mode having a second effective index strictly greater than the first effective index, the coupling structure comprising:
a first waveguide comprising a core configured to guide the first optical mode, the core extending beyond the first waveguide in an extension comprising a proximal section, close to the first waveguide, and a distal section in contact with the proximal section,
a second waveguide comprising a base and a ridge, configured to guide the second optical mode,
a hybrid waveguide, interposed between the first and second waveguides, comprising the proximal section and an extension of the base beyond the second waveguide, arranged to cooperate to guide an intermediate optical mode optically coupled to the first optical mode by the extension, and
a modal transition section extending from the hybrid waveguide to the second waveguide, comprising the distal section;
wherein the coupling structure is such that:
the proximal section has a width at a junction with the distal section such that an effective index of the intermediate optical mode is strictly greater than the second effective index, and
the distal section continuously narrows away from the hybrid waveguide so as to perform optical coupling between the intermediate optical mode and the second optical mode.

2. The coupling structure according to claim 1, wherein the proximal section is separated from the extension of the base by a dielectric interlayer portion.

3. The coupling structure according to claim 2, wherein the interlayer portion is made of silicon oxide or aluminum oxide.

4. The coupling structure according to claim 1, wherein the extension further comprises a buffer section interposed between the first waveguide and the proximal section, the extension of the base comprises a bevel facing the buffer section making an angle α less than or equal to 10° with an optical axis of the first waveguide, and extending on either side of the buffer section.

5. The coupling structure according to claim 4, wherein the proximal section is separated from the extension of the base by a dielectric interlayer portion and wherein the angle α is less than or equal to 8°, and the buffer section has a width between 1.3 μm and 2 μm.

6. The coupling structure according to claim 5, wherein the interlayer portion has a thickness S between 50 nm and 200 nm.

7. The coupling structure according to claim 1, wherein the core is made of silicon nitride and the base is made of lithium niobate, lithium tantalate, or barium titanate.

8. The coupling structure according to claim 7, wherein the ridge is made of lithium niobate, lithium tantalate, barium titanate, silicon nitride, titanium oxide, tantalum oxide, silicon carbide, or silicon.

9. The coupling structure according to claim 1, wherein the ridge has a width W₃₂₀ greater than or equal to 450 nm.

10. The coupling structure according to claim 9, wherein the coupling structure further comprises a substrate, the second waveguide extends parallel to an upper face of the substrate and the ridge has sidewalls having an angle less than or equal to 80° relative to the upper face of the substrate.

11. The coupling structure according to claim 1, wherein the extension has a height H_{2b} such that the effective index of any optical mode of the same wavelength and of the same polarization as the first optical mode, likely to propagate in the extension, is strictly lower than the first effective index.

12. An optical modulator comprising the coupling structure according to claim 1.

13. The optical modulator according to claim 12, wherein the modulator is a Mach-Zehnder modulator comprising two arms, one arm comprising a Pockels effect tunable phase shifter, optically coupled to the second waveguide of the coupling structure by butt coupling.

14. A method for manufacturing the coupling structure according to claim 1, comprising the following successive steps:
providing a first assembly comprising a substrate, the core of the first waveguide and an upper optical confinement layer, such that the core extends over the substrate parallel to an upper face of the substrate, and the upper optical confinement layer encapsulates the core,
transferring an active layer onto the core and the upper optical confinement layer, and
forming the second waveguide in the active layer.

15. The manufacturing method according to claim 14, wherein the proximal section of the coupling structure is separated from the extension of the base by a dielectric interlayer portion; wherein the upper optical confinement layer has a bonding face covering the core, substantially parallel to the upper face; wherein the transfer step comprises a molecular bonding of the bonding face with a bonding layer in contact with the active layer; and wherein the interlayer portion consists of a part of the upper optical confinement layer and a part of the bonding layer.

16. The manufacturing method according to claim 15, wherein the upper optical confinement layer and the bonding layer are made of silicon oxide.

17. The manufacturing method according to claim 14, wherein the active layer is made of lithium niobate, lithium tantalate, or barium titanate.
